(19) United States
(12) Patent Application Publication
(10) Pub. No.: US 2021/0356809 A1
(43) Pub. Date: Nov. 18, 2021

(54) Color Filter Substrate, Method for Fabricating Same, and Liquid Crystal Display Panel Comprising Same

(71) Applicant: TCL China Star Optoelectronics Technology Co., LTD., Shenzhen, Guangdong (CN)

(72) Inventor: Zhiming XU, Shenzhen, Guangdong (CN)

(21) Appl. No.: 16/615,361

(22) PCT Filed: Oct. 23, 2019
(86) PCT No.: PCT/CN2019/112710

§ 371 Date: Nov. 20, 2019

(30) Foreign Application Priority Data
Sep. 3, 2019 (CN) 201910828323.2

(51) Int. Cl. G02F 1/1335; G02F 1/167; G02F 1/1337

(52) U.S. Cl. CPC G02F 1/133516; G02F 1/133703; G02F 1/133796; G02F 1/167

(57) ABSTRACT

The present disclosure provides a method for fabricating a color filter substrate. The method comprises: forming an indium tin oxides (ITO) layer on a surface of the glass substrate and depositing a silver nanoparticle layer on a surface of the ITO layer by electrophoretic deposition to obtain a conductive layer. The present disclosure further provides a color filter substrate fabricated by the above method and a liquid crystal display panel comprising the same. The deposition of silver nanoparticles on the surface of the ITO layer by electrophoretic deposition reduces an impedance of the ITO layer, thereby reducing resistor-capacitor delay and making a liquid crystal alignment more complete.

### FIELD OF INVENTION

The present disclosure relates to a field of display technology, and particularly to a color filter substrate, a method for fabricating the same, and a liquid crystal display panel comprising the same.

### BACKGROUND

At present, high vertical alignment (HVA) in a thin film transistor-liquid crystal display (TFT-LCD) panel is an important process whose main function is to give a pretilt angle to liquid crystal molecules in a cell-assembled TFT-LCD panel. Thereby, the liquid crystal molecules can be rotated faster when the TFT-LCD panel operates, to improve response times of the TFT-LCD panel. The HVA must be powered. A current is supplied by a metal circuit board and is introduced into an indium tin oxide (ITO) conductive layer on a color filter substrate through an array substrate. Finally, a pressure difference occurs between the array substrate and the color filter substrate to realize deflection of the liquid crystal molecules. However, due to an excessive impedance of a current ITO conductive layer, an HVA signal is delayed, which affects normal alignment of liquid crystal molecules.

In the above, with respect to a current color filter substrate, a method for fabricating the same, and a liquid crystal display panel comprising same, due to an excessive impedance of an ITO conductive layer, an HVA signal is delayed, which affects normal alignment of liquid crystal molecules.

With respect to a current color filter substrate, a method for fabricating the same, and a liquid crystal display panel comprising same, an HVA signal is delayed due to an excessive impedance of an ITO conductive layer, thereby affecting normal alignment of liquid crystal molecules.

### SUMMARY OF DISCLOSURE

The present disclosure provides a color filter substrate, a method for fabricating same, and a liquid crystal display panel comprising same, which can reduce an impedance of an ITO conductive layer, to solve the technical problems that, with respect to a current color filter substrate, a method for fabricating same, and a liquid crystal display panel comprising same, an HVA signal is delayed due to an excessive impedance of an ITO conductive layer, thereby affecting a normal alignment of liquid crystal molecules.

In order to solve the above problems, the present disclosure provides technical solutions as follows.

The present disclosure provides a method for fabricating a color filter substrate. The method comprises:

S10: providing a glass substrate and forming an indium tin oxides (ITO) layer on a surface of the glass substrate; and

S20: depositing a silver nanoparticle layer on a surface of the ITO layer by electrophoretic deposition to obtain a conductive layer.

In an embodiment, S20 comprises:

S201: preparing a silver-containing electrophoresis solution and placing the silver-containing electrophoresis solution in an electrophoresis apparatus;

S202: placing the ITO layer and a conductive substrate in the electrophoresis apparatus, wherein the ITO layer is electrically connected to a negative electrode of the electrophoresis apparatus, and the conductive substrate is electrically connected to a positive electrode of the electrophoresis apparatus; and

S203: enabling the electrophoresis apparatus to electroplate the silver nanoparticle layer on the surface of the ITO layer for a period of time to obtain the conductive layer.

In an embodiment, in S201, the silver-containing electrophoresis solution is prepared by mixing silver nitrate, polyvinylpyrrolidone, and distilled water.

In an embodiment, a mass ratio of silver nitrate to polyvinylpyrrolidone in the silver-containing electrophoresis solution is 1:30.

In an embodiment, in S203, the electrophoresis apparatus is operated at 10V, and the period of time is 10 minutes.

The present disclosure further provides a color filter substrate. The color filter substrate comprises a glass substrate and a conductive layer disposed on the glass substrate. The conductive layer comprises an indium tin oxides (ITO) layer and a silver nanoparticle layer disposed on the ITO layer.

In an embodiment, the conductive layer is made by depositing silver nanoparticles on the ITO layer via electrophoretic deposition.

In an embodiment, the conductive layer having a low impedance is made by depositing silver nanoparticles on the ITO layer via electrophoretic deposition.

In an embodiment, an electrophoretic deposition solution used in the electrophoretic deposition is prepared by mixing silver nitrate, polyvinylpyrrolidone, and distilled water. A mass ratio of silver nitrate to polyvinylpyrrolidone is 1:30.

In an embodiment, the electrophoretic deposition is performed using an electrophoresis apparatus operated at 10V for 10 minutes.

The present disclosure further provides a liquid crystal display panel comprising the aforementioned color filter substrate.

With respect to a color filter substrate provided by the present disclosure, a method for fabricating same, and a liquid crystal display panel comprising same, deposition of silver nanoparticles on a surface of an ITO layer by electrophoretic deposition reduces an impedance of the ITO layer, thereby reducing resistor-capacitor delay and making a liquid crystal alignment more complete.

### BRIEF DESCRIPTION OF DRAWINGS

In order to more clearly illustrate the technical solutions in the embodiments of the present disclosure, a brief description of accompanying drawings used in the description of the embodiments of the present disclosure will be given below. Obviously, the accompanying drawings in the following description are merely some embodiments of the present disclosure. For those skilled in the art, other drawings may be obtained from these accompanying drawings without creative labor.

FIG. 1 is a flowchart of a method for fabricating a color filter substrate according to an embodiment of the present disclosure.

FIGS. 2A and 2B are schematic flowcharts of a method for fabricating a color filter substrate according to an embodiment of the present disclosure.

FIG. 3 is a schematic structural view of a color filter substrate according to an embodiment of the present disclosure.

FIG. 4 is a schematic structural view of a liquid crystal display panel according to an embodiment of the present disclosure.

### DETAILED DESCRIPTION

The following description of various embodiments of the present disclosure with reference to the accompanying drawings is used to illustrate specific embodiments that can be practiced. Directional terms mentioned in the present disclosure, such as “above”, “below”, “front”, “rear”, “left”, “right”, “inside”, “outside”, “side”, are merely used to indicate the direction of the accompanying drawings. Therefore, the directional terms are used for illustrating and understanding the present disclosure rather than limiting the present disclosure. In the figures, elements with similar structures are indicated by the same reference numerals.

Embodiments of the present disclosure can solve the technical problems that, with respect to a current color filter substrate, a method for fabricating same, and a liquid crystal display panel comprising same, an HVA signal is delayed due to an excessive impedance of an ITO conductive layer, thereby affecting a normal alignment of liquid crystal molecules.

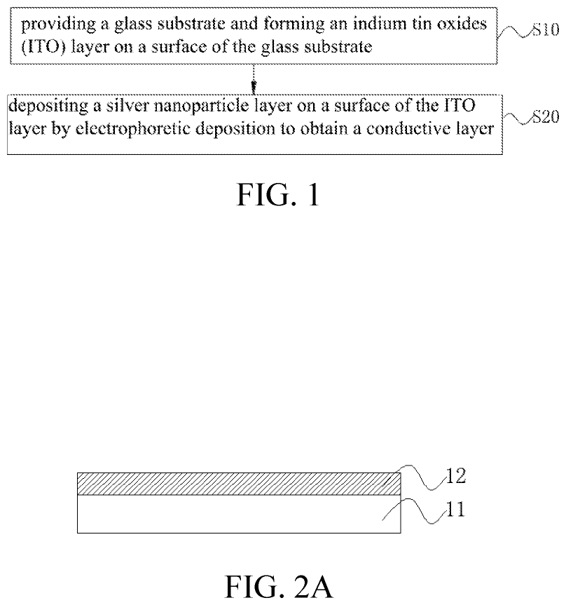

Please refer to FIG. 1, which is a flowchart of a method for fabricating a color filter substrate according to an embodiment of the present disclosure. The method comprises S10 and S20.

S10: providing a glass substrate 11 and forming an indium tin oxides (ITO) layer 12 on a surface of the glass substrate 11.

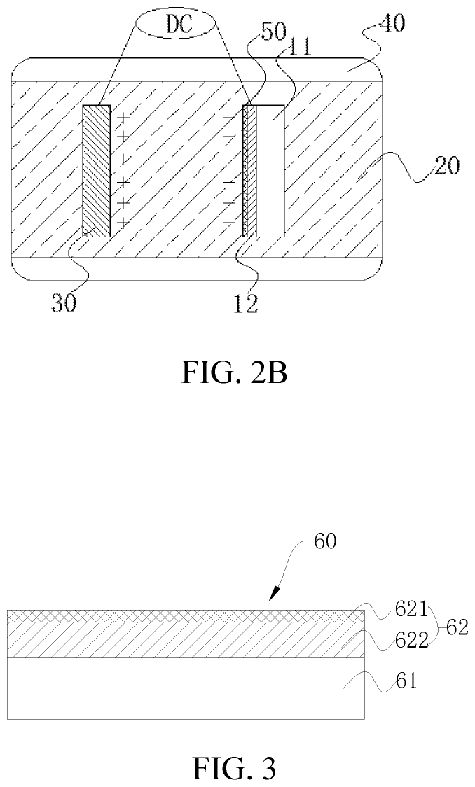

Specifically, as shown in FIG. 2A, S10 comprises:

providing a glass substrate 11, cleaning the glass substrate 11 with ultrasonic waves to completely remove an oxide layer and oil stains on a surface of the glass substrate 11, and depositing indium tin oxide (ITO) on the surface of the glass substrate 11 by magnetron sputtering to form an ITO layer 12. The magnetron sputtering preferably adopts a direct-current/radiofrequency power supply, a sputtering voltage of 150-180 V, a magnetic field strength of 1000-1500 G, and a mixed gas of Ar and O₂. The volume ratio of Ar:O₂ in the mixed gas is 2:1.

S20: depositing a silver nanoparticle layer 50 on a surface of the ITO layer 12 by electrophoretic deposition to obtain a conductive layer.

Specifically, as shown in FIG. 2B, S20 comprises:

First, a silver-containing electrophoresis solution 20 is prepared. Silver nitrate, polyvinylpyrrolidone (PVP) and distilled water are mixed and homogenized by sonication for one hour to obtain the silver-containing electrophoresis solution 20. The silver-containing electrophoresis solution 20 is placed in an electrophoresis apparatus 40. Preferably, a mass ratio of silver nitrate to polyvinylpyrrolidone in the silver-containing electrophoresis solution 20 is 1:30. Thereafter, the ITO layer 12 and a conductive substrate 30 are placed in the electrophoresis apparatus 40. The ITO layer 12 is electrically connected to a negative electrode of the electrophoresis apparatus 40, and the conductive substrate 30 is electrically connected to a positive electrode of the electrophoresis apparatus 40. Thereafter, a power source (DC) for the electrophoresis apparatus 40 is turned on, thereby enabling the electrophoresis apparatus 40 to electroplate the silver nanoparticle layer 50 on a surface of the ITO layer 12 for a period of time. The silver nanoparticle layer 50 is deposited at unevenness of the ITO layer 12 to fill defects on the surface of the ITO layer 12, thereby improving conductivity of the ITO layer 12. Finally, a conductive layer is obtained. The glass substrate 11 and the conductive layer constitute a color filter substrate.

Preferably, the electrophoresis apparatus 40 is operated at 10V, and the period of time is 10 minutes.

Specifically, the method for fabricating the color filter substrate of the present disclosure can control morphology of silver nanoparticles of the silver nanoparticle layer 50 by regulating the mass ratio of silver nitrate to polyvinylpyrrolidone (PVP) in the silver-containing electrophoresis solution 20.

Specifically, the method for fabricating the color filter substrate of the present disclosure can control a thickness of the silver nanoparticle layer 50 by adjusting a deposition voltage and an operating time of the electrophoresis apparatus 40, and a distance between the ITO layer 12 and the conductive substrate 30. Finding optimum process conditions can effectively achieve a preparation of a low-impedance conductive layer.

Specifically, in the method for fabricating the color filter substrate of the present disclosure, the silver nanoparticle layer 50 is deposited at unevenness of the ITO layer 12. On the one hand, the defects on the surface of the ITO layer 12 are filled, thereby improving conductivity of the ITO layer 12. On the other hand, thickness reduction of the ITO layer 12 can be achieved, thereby reducing production costs.

As shown in FIG. 3, the present disclosure further provides a color filter substrate. The color filter substrate 60 comprises a glass substrate 61 and a conductive layer 62 disposed on the glass substrate 61. The conductive layer 62 comprises an indium tin oxides (ITO) layer 621 and a silver nanoparticle layer 622 disposed on the ITO layer 621.

Specifically, the conductive layer 62 is made by depositing silver nanoparticles on the ITO layer 621 via electrophoretic deposition. An electrophoretic deposition solution used in the electrophoretic deposition is prepared by mixing silver nitrate, polyvinylpyrrolidone, and distilled water. A mass ratio of silver nitrate to polyvinylpyrrolidone is 1:30. The electrophoretic deposition is performed using an electrophoresis apparatus operated at 10V for 10 minutes.

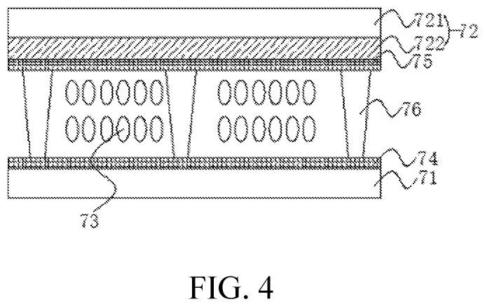

As shown in FIG. 4, the present disclosure further provides a liquid crystal display panel. The liquid crystal display panel comprises an array substrate 71, a color filter substrate 72, and a liquid crystal layer 73 disposed between the array substrate 71 and the color filter substrate 72.

Specifically, a first alignment film 74 is disposed on a surface of the array substrate 71 near the color filter substrate 72; and a second alignment film 75 is disposed on a surface of the color filter substrate 72 near the array substrate 71.

The color filter substrate 72 comprises a glass substrate 721 and a conductive layer 722 disposed on the glass substrate 721. The conductive layer 722 comprises an indium tin oxides (ITO) layer and a silver nanoparticle layer disposed on the ITO layer.

Specifically, the conductive layer 722 is made by depositing silver nanoparticles on the ITO layer via electrophoretic deposition.

Specifically, an electrophoretic deposition solution used in the electrophoretic deposition is prepared by mixing silver nitrate, polyvinylpyrrolidone, and distilled water. Morphology of silver nanoparticles of the silver nanoparticle layer can be controlled by regulating a mass ratio of silver nitrate to polyvinylpyrrolidone (PVP). Preferably, the mass ratio of silver nitrate to polyvinylpyrrolidone is 1:30.

Specifically, in the electrophoretic deposition, a thickness of the silver nanoparticle layer can be controlled by adjusting a deposition voltage and an operating time of the electrophoresis apparatus. Finding optimum process conditions can effectively achieve a preparation of the conductive layer 722. Preferably, the electrophoretic deposition is performed using an electrophoresis apparatus operated at 10V for 10 minutes.

Specifically, a plurality of spacers 76 is further disposed between the color filter substrate 72 and the array substrate 71.

The conductive layer 722 in the liquid crystal display panel of the present disclosure has excellent electrical properties due to excellent conductivity of the silver nanoparticle layer. Therefore, the ITO impedance is reduced, thereby reducing the delay effect of the resistor and capacitor, and achieving a better alignment effect of the HVA alignment process.

Use of the conductive layer 722 in an HVA alignment process can reduce a number of HVA curing pads, thereby optimizing design and saving changeover costs.

The conductive layer 722 is prepared by electrophoretic deposition. A deposition apparatus is simple and has a significant cost advantage over a physical vapor deposition (PVD) apparatus. Furthermore, ITO is a rare metal and expensive. Therefore, the electrophoretic deposition of silver on the surface of the ITO layer can achieve thinning of the ITO layer and reduce cost.

With respect to a color filter substrate provided by the present disclosure, a method for fabricating same, and a liquid crystal display panel comprising same, deposition of silver nanoparticles on a surface of an ITO layer by electrophoretic deposition reduces an impedance of the ITO layer, thereby reducing resistor-capacitor delay and making a liquid crystal alignment more complete.

In the above, the present application has been described in the above preferred embodiments, but the preferred embodiments are not intended to limit the scope of the present application, and those skilled in the art may make various modifications without departing from the scope of the present application. The scope of the present application is determined by claims.

What is claimed is:

1. A method for fabricating a color filter substrate, comprising:
S10: providing a glass substrate and forming an indium tin oxides (ITO) layer on a surface of the glass substrate; and
S20: depositing a silver nanoparticle layer on a surface of the ITO layer by electrophoretic deposition to obtain a conductive layer.

2. The method for fabricating the color filter substrate according to claim 1, wherein S20 comprises:
S201: preparing a silver-containing electrophoresis solution and placing the silver-containing electrophoresis solution in an electrophoresis apparatus;
S202: placing the ITO layer and a conductive substrate in the electrophoresis apparatus, wherein the ITO layer is electrically connected to a negative electrode of the electrophoresis apparatus, and the conductive substrate is electrically connected to a positive electrode of the electrophoresis apparatus; and
S203: enabling the electrophoresis apparatus to electroplate the silver nanoparticle layer on the surface of the ITO layer for a period of time to obtain the conductive layer.

3. The method for fabricating the color filter substrate according to claim 2, wherein in S201, the silver-containing electrophoresis solution is prepared by mixing silver nitrate, polyvinylpyrrolidone, and distilled water.

4. The method for fabricating the color filter substrate according to claim 3, wherein a mass ratio of silver nitrate to polyvinylpyrrolidone in the silver-containing electrophoresis solution is 1:30.

5. The method for fabricating the color filter substrate according to claim 3, wherein in S203, the electrophoresis apparatus is operated at 10V, and the period of time is 10 minutes.

6. A color filter substrate, comprising:
a glass substrate; and
a conductive layer disposed on the glass substrate;
wherein the conductive layer comprises an indium tin oxides (ITO) layer and a silver nanoparticle layer disposed on the ITO layer.

7. The color filter substrate according to claim 6, wherein the conductive layer is made by depositing silver nanoparticles on the ITO layer via electrophoretic deposition.

8. The color filter substrate according to claim 7, wherein an electrophoretic deposition solution used in the electrophoretic deposition is prepared by mixing silver nitrate, polyvinylpyrrolidone, and distilled water, and a mass ratio of silver nitrate to polyvinylpyrrolidone is 1:30.

9. The color filter substrate according to claim 7, wherein the electrophoretic deposition is performed using an electrophoresis apparatus operated at 10V for 10 minutes.

10. A liquid crystal display panel, comprising the color filter substrate according to claim 6.
